(19) United States
(12) Patent Application Publication
(10) Pub. No.: US 2026/0140972 A1
(43) Pub. Date: May 21, 2026

(54) DETERMINING SEMANTIC AND GRAMMATICAL CORRECTNESS OF USER-EXPANDED SENTENCE USING INTEGRATED PROGRAMMATIC AND SPECIALIZED GUIDED AND CONSTRAINED ARTIFICIAL INTELLIGENCE

(71) Applicant: 2hr Learning, Inc., Austin, TX (US)

(72) Inventors: Joshua Singer, Austin, TX (US); Cameron Kelley, Franklin, TN (US)

(73) Assignee: 2hr Learning, Inc., Austin, TX (US)

(21) Appl. No.: 19/367,651

(22) Filed: Oct. 23, 2025

Related U.S. Application Data
(60) Provisional application No. 63/711,127, filed on Oct. 23, 2024.

(51) Int. Cl. G06F 16/332; G06F 16/3332; G06F 40/253; G06F 40/284; G06F 40/30; G06F 40/40

(52) U.S. Cl. CPC G06F 16/3326; G06F 16/3334; G06F 40/253; G06F 40/284; G06F 40/30; G06F 40/40

(57) ABSTRACT

A system and method guide an Artificial Intelligence engine to determine the semantic and grammatical correctness of a user-expanded sentence in real-time. The sentence validation process involves receiving input from the user, the input includes sentence fragment that the user wishes to expand and user-expanded sentence that the user constructs on the fragment provided. The inputs are broken down into tokens. The word-level tokenization algorithm is used, which identifies tokens by splitting the text into spaces, punctuation marks, and other delimiters. Further, a token comparison algorithm is used to assess the relationship between the sentence fragment and the user-expanded sentence to analyze order and placement. Once the token comparison is complete, a prompt is generated using prompt generator to evaluate grammatical and semantic evaluation of the user-expanded sentence. Real-time feedback is provided to the user based on grammatical and semantic evaluation.

### CROSS-REFERENCE TO RELATED APPLICATION(S)

This application claims the benefit under 35 U.S.C. § 119 (e) and 37 C.F.R. § 1.78 of U.S. Provisional Application No. 63/711,127, which is incorporated by reference in its entirety.

### FIELD OF THE INVENTION

The present invention relates in general to the field of electronics, and more specifically to sentence validation systems and sentence validation methods to determine the semantic and grammatical correctness of user-expanded sentences in real-time.

### BACKGROUND

The grammar checkers have long been relied upon to correct basic syntax errors and ensure adherence to grammatical rules. Traditional grammar checkers are designed to identify and correct errors related to the structure of sentences, such as subject-verb agreement, punctuation, verb tense consistency, and sentence fragments. The traditional grammar checkers emphasize on ensuring that the sentences conform to established norms of grammar. The norms dictate how words and phrases should be organized to form grammatically correct sentences, whether in terms of sentence length, the proper use of conjunctions, or the correct placement of modifiers. The traditional grammar checkers identify mistakes based on pre-programmed grammatical guidelines.

Typically, traditional grammar checkers lack the ability to analyze semantic correctness of sentences comprehensively. While traditional grammar checkers ensure that a sentence follows proper syntactical rules, these checkers fail to assess that the sentence accurately reflects the meaning of its component parts. This may lead to inaccurate sentence formations especially in scenarios where fragments of sentences are expanded into full sentences. In other words, when a student expands a sentence fragment into a complete sentence, the grammar checker confirms that the newly formed sentence is grammatically sound, but it fails to evaluate that the expanded sentence preserves the original meaning of the fragment. As a result, the sentence is grammatically correct, but the expanded version changes the meaning of the original.

Generally, the sentence correctness has been evaluated manually by teachers. The process of manually evaluating student's work including sentence expansions and the assessment of grammar and meaning has been a long-standing practice. Teachers are typically responsible for reviewing student submissions, checking them for grammatical accuracy, coherence, and meaning. While teachers can assess both the syntactic and semantic correctness of sentences, the manual evaluation method of sentence correctness presents several limitations. First, the manual method is time-consuming as teachers must review large volumes of student work, especially with high student-to-teacher ratios. Manually reviewing each sentence for both grammatical and semantic accuracy requires a considerable amount of time, especially where teachers are already burdened with other responsibilities like lesson planning, grading, and student feedback.

Second, the manual evaluation of sentence correctness is subject to human error and inconsistency. Errors in judgment may arise from fatigue, time pressure, or the sheer volume of tasks that teachers must handle. In addition to this, individual teachers may apply different standards when assessing student work, which can lead to inconsistency in feedback. Some teachers might place greater emphasis on grammatical accuracy, while others might prioritize clarity of meaning or creativity in sentence construction. This inconsistency can be especially problematic when dealing with semantic differences, where a slight variation in sentence meaning may be interpreted differently by different teachers. Such subjective variations in evaluation can affect the quality of feedback provided to students and may result in students receiving conflicting messages about how to improve their writing.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary sentence validation system for determining the semantic and grammatical correctness of a user-expanded sentence in real-time.

FIG. 2 depicts an exemplary sentence validation process utilized by the sentence validation system.

FIG. 3 depicts an exemplary decision-making process, which is an embodiment of the sentence validation process of FIG. 2.

FIG. 4 depicts an exemplary network environment in which the system of FIG. 1 and the process of FIG. 2 may be practiced.

FIG. 5 depicts an exemplary computer system.

### DETAILED DESCRIPTION

The system and method for guiding an Artificial Intelligence (AI) engine for determining the semantic and grammatical correctness of a user-expanded sentence in real-time. A sentence validation process receives user inputs, which includes a sentence fragment that the user wishes to expand and a user-expanded sentence that the user constructs based on the provided fragment. The inputs are broken down into tokens. A word-level tokenization algorithm is used, which identifies tokens by splitting the sentences text into spaces, punctuation marks, and other delimiters. Further, a token comparison algorithm is used to assess the relationship between the sentence fragment and the user-expanded sentence to analyze order and placement. Once the token comparison is complete, a prompt is generated using prompt generator to evaluate grammatical and semantic evaluation of the user-expanded sentence. Real-time feedback is provided to the user based on grammatical and semantic evaluation.

The AI engine evaluates the grammatical accuracy of the user-expanded sentence using a grammar checking algorithm to identify syntax mistakes, punctuation errors, and improper sentence structures. The AI engine utilizes grammar evaluation tool to enhance the detection of specific errors, such as subject-verb agreement mistakes and misplaced modifiers. The AI engine performs a semantic analysis of the user-expanded sentence through a multi-stage process. The AI engine identifies whether the expanded sentence conveys a meaning that aligns logically with the sentence fragment. The AI engine checks for consistency in meaning, ensuring that any expansions do not distort the original meaning or underlined intent. After grammatical and semantic evaluations, the results are synthesized to produce a Boolean output. The Boolean output indicates whether the user-expanded sentence is semantically and grammatically corrected in relation to the sentence fragment.

Real-time feedback is provided to the user based on the Boolean output. The real-time feedback is either confirmation of correctness or detailed error reporting. Confirmation of correction means that the user-expanded sentence meets both grammatical and semantic standards, whereas error reporting indicates that the user is informed about issues found in sentence expansion such that the user receives specific feedback identifying grammatical or semantic inconsistencies along with suggestions for improvement. Moreover, a database is used for storing the history of user-expanded sentences and the corresponding feedbacks. This allows users to review past expansions and their evaluations.

The system and method set forth herein address technical issues with generating the desired outputs described herein. Conventionally, manual processes were used to generate the desired outputs and were very tedious and time consuming. The present system and method utilize an automated system that does not merely automate a manual process or use a conventional system in a conventional way. The present system and method utilize one or more artificial intelligence (AI) engines and integrate programmatic process management to technologically guide and constrain the one or more AI engines to produce the desired outputs in a completely different way than any manual process and different than normal use of programs and AI engines. Utilizing specially engineered guidance and control to direct an AI system to solve the problems below presents a technical problem that requires a technical solution. The system and method described below are not simply engaging a computer to carry out conventional mental processes, but rather change how computers (and AI systems, specifically) operate to achieve the generation results that were not previously possible or were substantially inefficient prior to the system and method set forth below. The AI system needs specific technical guidance, control, and constraints to achieve results that are not otherwise achievable.

Prompts are used to guide and constrain each AI engine. The prompts guide each AI engine by steering the AI engine(s). “Guiding” an AI engine refers to providing the AI engine with a general direction or framework to shape the AI engine's behavior or decision-making process. Guiding sets goals or principles. Guiding allows the AI engine some flexibility to interpret and adapt, much like giving it a compass to navigate rather than a fixed path.

Constraining each AI engine includes imposing specific, hard limits or rules on what each AI engine can do. Constraining an AI engine can also include providing specific input data to not only guide but also constrain the scope of each AI engine's reasoning basis and response. Constraining each AI engine assists with aligning the AI engine(s) for its (their) intended use.

Normally AI engines are provided a single user prompt requesting the AI engine, such as OpenAI's ChatGPT and its various implementations such as Anthropic's Claude Sonnet, to perform a task and produce an output. However, this conventional AI engine prompting method has a variety of technical shortcomings. Without proper guidance and constraints, an AI engine will not produce the desired output specified as produced by the system and method described herein. Instead, the AI engine will produce many unusable outputs that are unusable for a variety of reasons including so-called “hallucinations” where the AI engine presents fabricated information, duplicate outputs, too few outputs, too many outputs, outputs that do not meet desired criteria, and so on. Without special technical guidance, the AI engine cannot reliably be applied to generate desired outcomes.

The system and method generate decomposed, technically engineered AI prompts to include selected and integral AI engine guidance and constraints. Conventional approaches often do not recognize the technical capabilities of an engineered prompt to guide and constrain an AI engine to generate a desired output. The technically engineered prompts are generated and guided with programmatic, automatic inputs specifically designed to unconventionally guide and constrain an AI engine to produce desired outputs, perform quality control to retain or automatically discard outputs that do not meet guidance and constraints, and make the desired outputs available for use, such as use by computer system applications. In at least one embodiment, the problem to be solved by the integrated programmatic and AI engine system and method is uniquely and unconventionally decomposed, and AI prompts are used to solve the decomposed problem. Furthermore, the programmatic inputs to the decomposed AI prompts provide guidance to meet desired output characteristics.

Determining a number of prompts, the guidance and constraints within each prompt, and data flowing from one AI engine prompt to another, in addition to testing a number of prompts for the decomposed problem, testing within each prompt, and validating a desired quality of outputs becomes an intractable combinatorial problem without technical guidance and constraint of the system and method described herein. Thus, the present system and method described implement an integration of programmatic management over decomposed prompts with engineered AI engine guidance and constraints to effect an improvement in AI, programmatic AI management, and AI integrated with programmatic management technology. The present system and method allow computer systems to include programmatic management, one or more AI engines, and one or more data sources to produce the output described herein that previously could not be produced with conventionally prompted AI engines or could only be produced by humans utilizing a completely different, time consuming, and tedious process. The system and method improve conventional methods through the use of a programmatic AI engine management system to generate decomposed, technically engineered AI prompts to include selected and integral AI engine guidance and constraints. It is, for example, the incorporation of the programmatic AI engine management system to generate decomposed, technically engineered AI prompts to include generated, integral, and unconventional AI engine guidance and constraints and execution by the one or more AI engines to provide useful results that improve existing technical processes, which is not an automation of a conventional process.

Programmatic components and AI engines generally utilize one or more processors that have access to memory, which may include one or more storage components, to execute and perform functions. An AI engine is a core hardware and software system that enables artificial intelligence applications to process data, learn patterns, and generate insights or actions. It functions as the brain behind AI-driven systems, facilitating tasks such as machine learning, natural language processing, and decision-making. Exemplary components of an AI engine are:
1. Machine Learning Models—Algorithms that analyze data, recognize patterns, and make predictions.
2. Neural Networks—Deep learning architectures that mimic the human brain for tasks like image and speech recognition.
3. Data Processing Module—Handles raw data input, transformation, and feature extraction.
4. Inference Engine—Applies trained models to make real-time decisions based on new data.
5. Optimization Algorithms—Improves model efficiency, reducing errors and improving predictions.
6. Natural Language Processing (NLP) Module—Enables AI engines to understand, interpret, and generate human language (e.g., chatbots, voice assistants).
7. Computer Vision Module—Allows AI to interpret and analyze images or videos.
8. Reinforcement Learning Mechanism—Helps AI learn from trial and error, optimizing performance over time.
9. API Interface—Connects the AI engine with applications, enabling integration with other software or platforms.

Examples of AI Engines include: XAI's Grok and variations thereof, Google TensorFlow, Meta's PyTorch, Microsoft Azure AI, OpenAI's ChatGPT and variations thereof, IBM Watson, OpenAI Whisper, Google BERT & T5, Amazon Lex, Anthropic Claude, DeepMind's AlphaCode, Google Vision AI, Meta's DINO & SAM (Segment Anything Model), NVIDIA DeepStream. OpenCV AI Kit, Amazon Polly. Google WaveNet, Deepgram.

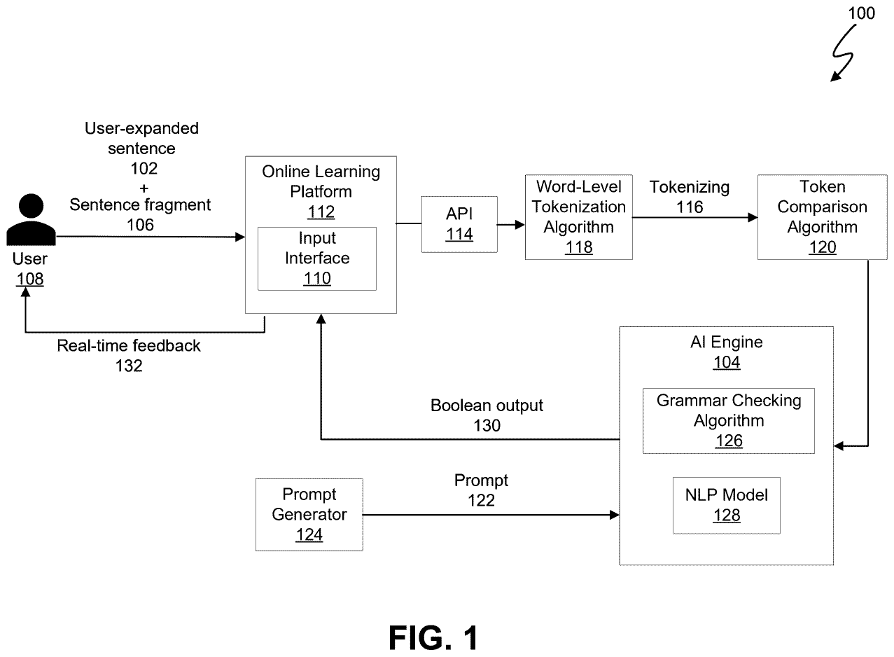

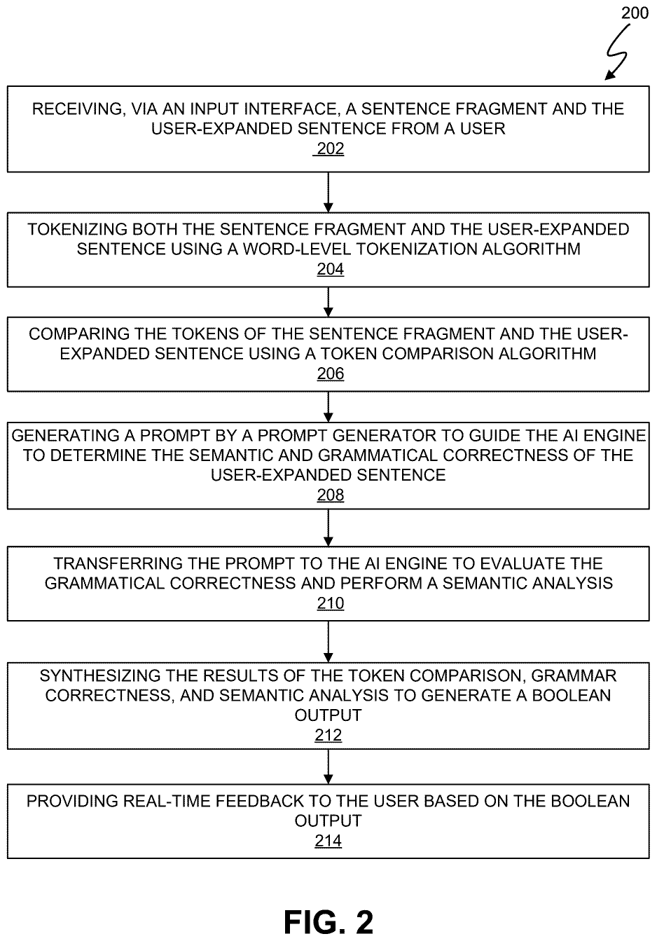

FIG. 1 depicts an exemplary sentence validation system 100 for determining the semantic and grammatical correctness of a user-expanded sentence 102 in real-time. FIG. 2 depicts an exemplary sentence validation process 200 utilized by the sentence validation system 100.

The Artificial Intelligence (AI) engine 104 is designed for determining the semantic and grammatical correctness of a user-expanded sentence 102 in real-time. The AI engine 104 receives both sentence fragment 106 and user-expanded sentence 102. The AI engine 104 evaluates the grammatical correctness of the user-expanded sentence 102 and performs a semantic analysis of the user-expanded sentence 102 to provide feedback including corrective measures to the user 108.

Referring to FIGS. 1 and 2, in operation 202, receiving, via an input interface 110, a sentence fragment 106 and the user-expanded sentence 102 from the user 108 on an online learning platform 112. The input interface 110 allows communication between the user 108 and the online learning platform 112. The input interface 110 receives input provided by the user 108 in a structured manner. The input interface 110 displays the sentence fragment 106 to the user 108 and based on the displayed sentence fragment 106 the user 108 provides the user-expanded sentence 102.

Typically, the sentence fragment 106 is a group of words that looks like a sentence but is not complete and cannot stand on its own. The sentence fragment 106 occurs when a sentence is missing a subject, a verb, or when the sentence does not express a complete idea. For example, “Went to the store yesterday”, “After the classes, the library”, “My life nowadays”, “Shows no improvement in any of the vital signs” and the like. Typically, the user 108 is working on expanding the sentence fragment 106 to form a complete sentence. The user-expanded sentence 102 refers to the completed version of that sentence fragment 106, where the user 108 further elaborate on the fragment to form the complete statement. The purpose of receiving the sentence fragment 106 and the user-expanded sentence 102 is to assist the user 108 in constructing sentences, improving language structure, or generating more complex text from simpler input. Another example of the sentence fragment 106 is “I ate”. This is an incomplete sentence. It provides a subject (“I”) and a verb (“ate”), but lacks additional details such as an object. The user-expanded sentence 102 is “I ate an apple”. This is the complete sentence that the user 108 has created by expanding the sentence fragment 106. The user 108 has added the object “an apple”, which completes the thought.

Moreover, the sentence fragment 106 and the user-expanded sentence 102 are received from a user device through the input interface 110 to enable interaction. The user device refers to any device the user 108 uses to interact with the online learning platform 112, such as a smartphone, tablet, laptop, personal computer, and so forth. The user device serves as a medium through which the user 108 receives the sentence fragment 106 and provides the user-expanded sentence 102. For example, the user 108 types a sentence like “I ate” on the input interface 110 or dictates it via voice input. The user device captures the input and sends through the input interface 110, which is designed to handle the interaction in a user-friendly manner. The input interface 110 facilitates the user-expanded sentence 102. The input interface 110 allows the user 108 to input the user-expanded sentence 102 for the sentence fragment 106. The input interface ensures the user 108 experience is smooth and intuitive. The interaction between user device and input interface 110 enables a seamless flow of information, ensuring the user inputs are received in a structured and accurate manner.

In operation 204, tokenizing 116 the sentence fragment 106 and the user-expanded sentence 102 is done using a word-level tokenization algorithm 118. The word-level tokenization algorithm 118 receives the sentence fragment 106 and the user-expanded sentence 102 via an API 114. Tokenizing 116 includes breaking down the sentences text such as the sentence fragment 106 and the user-expanded sentence 102 into discrete tokens, based on spaces, punctuation, and other delimiters. Tokenizing 116 is the process of converting text into smaller, discrete units known as tokens. The tokens can be words, phrases, or even smaller elements depending on the level of granularity required. The word-level tokenization algorithm 118 breaks down sentences into individual words by identifying boundaries in the text, such as spaces, punctuation marks, or other delimiters. The tokenizing 116 process seeks to convert text from a continuous string into smaller, discrete components. For example, if the sentence fragment 106 is like “I ate,” word-level tokenization would split it into two tokens: “I” and “ate.” The tokens are the smaller pieces of text generated after tokenization. Each token represents an individual word or symbol extracted from both the sentence fragment 106 and the user-expanded sentence 102. Tokenization of sentence “I ate an apple” results into tokens “I”, “ate”, “an”, and “apple”.

The word-level tokenization algorithm 118 is a set of rules or a computational method used to break text into individual tokens based on word boundaries. The word-level tokenization algorithm 118 identifies spaces between words as primary delimiters but can also use punctuation marks such as commas, periods, or question marks and other symbols as indicators for where one token ends and another begins. The word-level tokenization algorithm 118 reads through the text, identifies delimiters, and splits the text accordingly. For example, in the sentence “I ate an apple,” the word-level tokenization algorithm 118 would recognize the spaces as delimiters and split the text into four tokens. Tokenizing 116 allows continuous text to be processed in a structured way. Tokenizing 116 of both the sentence fragment 106 and the user-expanded sentence 102 allows for the comparison, transformation, or analysis of both inputs in a structured manner. By breaking down both the sentence fragment 106 and the user-expanded sentence 102 into tokens, tokenizing 116 enables how the fragment is expanded and what additional information is added by the user 108.

When tokenizing both the sentence fragment 106 and the user-expanded sentence 102, the word-level tokenization algorithm 118 applies the same tokenization rules. For example, given the sentence fragment 106 is “I ate” and the user-expanded sentence 102 “I ate an apple,” the word-level tokenization algorithm 118 first breaks down “I ate” into two tokens: “I” and “ate.” Then, it tokenizes the user-expanded sentence 102 “I ate an apple” into four tokens: “I,” “ate,” “an,” and “apple.” This consistent tokenization of both the sentence fragment 106 and the user-expanded sentence 102 allows a token comparison algorithm 120 to easily compare the two inputs and determine what additional information is added.

In operation 206, comparing the tokens of the sentence fragment 106 and the user-expanded sentence 102 using the token comparison algorithm 120. The comparison involves determining whether the meaning of the sentence fragment 106 is preserved in the user-expanded sentence 102 by assessing the presence, order, and contextual alignment of the corresponding tokens in both sentence fragment 106 and user-expanded sentence 102. The tokens generated from both the sentence fragment 106 and the user-expanded sentence 102 are compared to determine if there is any alteration in meaning, structure, or context. The token comparison algorithm 120 is utilized to compare the tokens. The token comparison algorithm 120 is the computational method or set of rules used to evaluate the relationship between the tokens from the sentence fragment 106 and the user-expanded sentence 102. The token comparison algorithm 120 examining how the tokens from both inputs match up in terms of their presence, whether all the original tokens of the sentence fragment 106 appear in the user-expanded sentence 102, their order whether the tokens appear in the same sequence, and their contextual alignment whether the user-expanded sentence 102 maintains the same meaning and intent as the sentence fragment 106.

Such a comparison ensures that the user-expanded sentence 102 preserves the meaning of the sentence fragment 106. When the user 108 expands sentence fragment 106, the user 108 adds information such as additional words or phrases to turn an incomplete sentence fragment 106 into a full sentence. However, during this expansion, there is a possibility that the meaning of the sentence fragment 106 could change if the user 108 introduces new concepts or rearranges the original tokens in a way that alters the original intent. Therefore, the comparison helps in evaluating whether the original intent of the sentence fragment 106 is maintained or if the user-expanded sentence 102 has deviated from the original meaning. Typically, the token comparison algorithm 120 checks whether all the tokens from the sentence fragment 106 are still present in the user-expanded sentence 102. If any tokens from the sentence fragment 106 are missing, it might indicate that the user-expanded sentence 102 has lost part of its original meaning. The token comparison algorithm 120 also identified if the tokens are arranged as they were present in the sentence fragment 106. The token comparison algorithm 120 ensures that the user-expanded sentence 102 conveys the same message as the sentence fragment 106, even with the added information by the user 108. The user-expanded sentence 102 may introduce new tokens such as new words or phrases) but if the new tokens fit logically and contextually with the original ones, the meaning of the sentence fragment 106 is considered preserved.

Typically, the token comparison algorithm 120 evaluates presence of tokens and relative order and position within the sentence. The token comparison algorithm 120 is designed to assess whether the user-expanded sentence 102 retains the essential structure and meaning of the sentence fragment 106. The token comparison algorithm 120 evaluates the presence of tokens from the sentence fragment 106 within the user-expanded sentence 102. For example, if the sentence fragment 106 is “I ate,” this would be tokenized into two tokens: “I” and “ate.” In the user-expanded sentence 102, such as “I ate an apple,” the token comparison algorithm 120 checks to ensure that the tokens “I” and “ate” are still present in the user-expanded sentence 102. The token comparison algorithm 120 flags any absence of tokens, signaling that the user-expanded sentence 102 has deviated from the core structure of the sentence fragment 106.

The token comparison algorithm 120 evaluates the relative order and position of tokens within both the sentence fragment 106 and the user-expanded sentence 102 to preserve the meaning of the sentence. For example, the sentence fragment 106 “I ate” follows a subject-verb structure, which conveys a specific meaning. If the user-expanded sentence 102 is “Ate I an apple,” even though the words “I” and “ate” are present, the order has been changed, which disrupts the sentence's coherence and meaning.

Moreover, comparing the tokens of the sentence fragment 106 and the user-expanded sentence 102 comprises handling cases where the user-expanded sentence 102 includes additional contextual information does not present in the sentence fragment 106. When the user 108 expands the sentence fragment 106, it includes extra information to make the sentence complete or contextually richer. For instance, the fragment “I ate” could be expanded to “I ate an apple at lunch.” In this example, the additional tokens “an apple” and “at lunch” introduce more specific details but do not change the essential meaning of the sentence fragment 106. The token comparison algorithm 120 evaluates whether such added information alters the original meaning of the sentence fragment 106, and rejects the expansion if significant deviations in meaning is detected.

When the token comparison algorithm 120 detects that the additional information alters the original meaning, the algorithm 120 rejects the user-expanded sentence 102. For example, if the user-expanded sentence 102 completely changes the tone, intent, or implication of the sentence fragment 106, the token comparison algorithm 120 concludes that the expansion no longer reflects the initial message and flags it as invalid. The token comparison algorithm 120 ensures that the user's expansion aligns with the original meaning of the sentence fragment 106 and maintains the integrity of the sentence structure.

In operation 208, generating a prompt 122 by a prompt generator 124 to guide the AI engine 104 to determine the semantic and grammatical correctness of the user-expanded sentence 102. The prompt 122 is an input or query generated to guide the AI engine 104 to evaluate whether the user-expanded sentence 102 is semantically and grammatically correct. The prompt 122 includes specific instructions or parameters that instruct the AI engine 104 to determine the meaning of individual words or phrases, the relationships between them, and how they align with established grammatical rules. The prompt generator 124 is a tool that is responsible for creating the prompt 122 that will be used to guide the AI engine 104. The prompt generator 124 constructs the query by considering the specific goals, such as assessing whether the meaning of the user-expanded sentence 102 matches the intended meaning of the sentence fragment 106 and whether the user-expanded sentence 102 adheres to the correct grammatical rules. The prompt generator 124 ensures that the prompt 122 is clear, relevant, and aligned with the task of evaluating the semantic and grammatical correctness of the user-expanded sentence 102. In at least one embodiment, the prompt 122 is generated by a prompt engineer.

The semantic correctness refers to whether the user-expanded sentence 102 conveys the intended meaning in a coherent and logical way. The prompt generator 124 helps the AI engine 104 to evaluate whether the user-expanded sentence 102 stays true to the original meaning intended in the sentence fragment 106 without introducing contradictions or inconsistencies. The grammatical correctness refers to whether the user-expanded sentence 102 follows the rules of grammar, including syntax, punctuation, and proper word forms. The grammar rules ensure that the user-expanded sentence 102 is structured in a way that is linguistically sound, making it readable and understandable. The prompt generator 124 ensures that the AI engine 104 receives the right prompt 122 to perform an accurate and detailed analysis of the user-expanded sentence 102.

The semantic correctness ensures that the user-expanded sentence 102 preserves the meaning of the sentence fragment 106. When the user 108 expands the sentence, they add new information, but the core meaning of the sentence fragment 106 should remain intact. For example, if the sentence fragment 106 is “I ate,” and the user-expanded sentence 102 is “I ate an apple,” the semantic meaning is still consistent. However, if the user-expanded sentence 102 is “I ate an apple because I was upset,” the added context introduces a new emotional layer that might alter the meaning. The grammatical correctness ensures that the user-expanded sentence 102 adheres to the rules of language. For example, if the user-expanded sentence 102 includes improper syntax “Apple ate I” instead of “I ate an apple”, the sentence becomes difficult or impossible to interpret.

In operation 210, transferring the prompt 122 to the AI engine 104. The AI engine 104 is a computational system that is designed to carry out complex tasks involving language understanding, data processing, and evaluation. The AI engine 104 is configured to process and analyze the user-expanded sentence 102 based on the prompt 122 to perform checking for grammatical correctness and semantic analysis. The prompt 122 acts as a set of instructions that guides the AI engine 104 to analyze the user-expanded sentence 102. The prompt 122 is typically transferred electronically or programmatically from the prompt generator 124 to the AI engine 104.

The AI engine 104 is configured to evaluate the grammatical correctness of the user-expanded sentence 102 using a grammar checking algorithm 126. The grammar checking algorithm 126 identifies grammatical errors including syntax mistakes, punctuation errors, and improper sentence structures. The grammar checking algorithm 126 integrated with the AI engine 104 analyzes the structure of the sentence, checking for syntax mistakes such as incorrect word order or verb tense, punctuation errors like missing commas or improper use of semicolons, and improper sentence structures such as incomplete or fragmented sentences. The grammatical correctness refers to the accuracy and conformity of a sentence to the rules of grammar. The rules govern how words are combined to form sentences, ensuring proper structure, clarity, and coherence.

The AI engine 104 evaluates the grammatical correctness of the user-expanded sentence 102 comprises utilizing the grammar checking algorithm 126 integrated with a grammar evaluation tool to identify grammatical issues including subject-verb agreement errors, run-on sentences, improper punctuation usage, misplaced modifiers, and stylistic concerns. The subject-verb agreement errors ensure that the subject and verb in the user-expanded sentence 102 agree in number and tense for example, “He runs” vs. “He run”. The run-on sentences identify the user-expanded sentence 102 improperly combining multiple independent clauses without appropriate conjunctions or punctuation. The improper punctuation usage flags errors related to the incorrect use of punctuation marks such as commas, periods, and apostrophes. The misplaced modifiers detect modifiers descriptive words or phrases) that are placed incorrectly, leading to confusion about what is being described. Identifying the grammatical issues ensures that the user-expanded sentence 102 is grammatically correct, follows the proper structure, and is easy to understand. The AI engine 104 uses grammar checking algorithm 126 integrated with the grammar evaluation tool to compare the sentence against grammatical rules.

The AI engine 104 evaluates the grammatical correctness of the user-expanded sentence 102 comprises assessing stylistic elements of the user-expanded sentence 102, including sentence length, complexity, tone, and readability to provide the user 108 with an enhanced assessment of the overall quality and effectiveness of the user-expanded sentence 102. The stylistic elements include aspects of the user-expanded sentence 102 that affect its tone, readability, and overall flow. The sentence length identifies whether the user-expanded sentence 102 is too long or too short. The complexity helps in identifying the difficulty level of the user-expanded sentence 102 in terms of word choice and structure. The tone helps in identifying whether the user-expanded sentence 102 is formal, casual, or neutral. Moreover, assessing the stylistic elements ensures that the user-expanded sentence 102 follows grammatical rules and also communicates effectively.

The AI engine 104 is configured to perform a semantic analysis of the user-expanded sentence 102 using a natural language processing (NLP) model 128. The NLP model 128 determines whether the meaning conveyed by the user-expanded sentence 102 is logically consistent and aligns with the sentence fragment 106. The AI engine 104 ensures that the user-expanded sentence 102 conveys a meaning that is logically consistent with the sentence fragment 106. The AI engine 104 analyzes the relationships between words, phrases, and clauses to express a clear and accurate meaning. The AI engine 104 uses NLP model 128 to evaluate the meaning of the user-expanded sentence 102. The NLP model 128 analyzes the relationships between different parts of the sentence such as subject, verb, and object to determine whether they form a coherent and logical meaning.

Moreover, performing semantic analysis on the user-expanded sentence 102 comprises using a multi-stage approach. The semantic analysis evaluates the syntactic structure of the user-expanded sentence 102 to determine whether the meaning conveyed by the user-expanded sentence 102 aligns with the intended meaning of the sentence fragment 106. The multi-stage approach involves analyzing the syntactic structure of the user-expanded sentence 102 and how words are arranged and related to each other. This is followed by evaluating the meaning or semantic relationships between these words and phrases, and finally, determining whether the meaning of the user-expanded sentence 102 aligns with the intent of the sentence fragment 106. The multi-stage approach allows analysis of both the structure and meaning of the user-expanded sentence 102. Typically, the AI engine 104 focus on evaluating the relationships between the words and concepts in the user-expanded sentence 102 and compares the meaning of the user-expanded sentence 102 with the sentence fragment 106 to check for consistency, ensuring that no contradictory or unrelated meanings have been introduced. In at least one embodiment, the multi-stage approach utilizes GPT-3.5-turbo model owned by OpenAI having headquarters in San Francisco.

In operation 212, synthesizing the results of the token comparison, grammar correctness, and semantic analysis to generate a Boolean output 130. The Boolean output 130 indicates whether the user-expanded sentence 102 is semantically and grammatically correct relative to the sentence fragment 106. Synthesizing the results refers to the process of combining and integrating data or outcomes from different sources or operations such as from token comparison, grammar correctness, and semantic analysis to form a unified judgment about the correctness of the user-expanded sentence 102. Typically, the token comparison ensures that the user-expanded sentence 102 maintains alignment with the sentence fragment 106, grammar correctness checks that the user-expanded sentence 102 follows the proper rules of syntax and punctuation, and semantic analysis ensures that the user-expanded sentence 102 conveys a coherent meaning consistent with the sentence fragment 106

Each evaluation provides an outcome whether the user-expanded sentence 102 passes or fails. The AI engine 104 processes them collectively to determine if all criteria are met. If all checks indicate that the user-expanded sentence 102 is correct, the final output will reflect that; if any of the checks identify an issue, the final output will indicate that the user-expanded sentence 102 is incorrect by providing the corresponding Boolean output 130. The Boolean output 130 is a binary result that can either be true or false. The Boolean output 130 represents the final determination about whether the user-expanded sentence 102 is semantically and grammatically correct relative to the sentence fragment 106. If the user-expanded sentence 102 passes all checks, the Boolean output 130 will be true indicating correctness. If any of the checks fail, the Boolean output 130 will be false indicating that the user-expanded sentence 102 contains errors.

The Boolean output 130 provides a clear, unambiguous result that is easy to interpret. In at least one embodiment, each token comparison, grammar correctness evaluation, and semantic analysis produces its own result such as pass or fail, and the AI engine 104 aggregates these results. If all three processes return positive outcomes indicating that the user-expanded sentence 102 is correct in terms of token alignment, grammar, and meaning, the Boolean output 130 is set to true. If any of the processes return a negative outcome indicating a problem with the user-expanded sentence 102, the Boolean output 130 is set to false.

In operation 214, providing real-time feedback 132 to the user 108 based on the Boolean output 130. The feedback includes either confirmation of correctness or detailed error reporting that identifies specific grammatical or semantic inconsistencies and provides suggestions for improving the user-expanded sentence 102. The immediate response is provided to the user 108 as soon as the AI engine 104 finishes evaluating the user-expanded sentence 102. The user 108 does not need to wait for long processing time, instead, they receive feedback 132 almost instantly. The feedback 132 can either confirm that the user-expanded sentence 102 is correct or provide error reports highlighting areas that need improvement. The real-time feedback 132 allows the user 108 to interact with the online learning platform 112 efficiently. The real-time feedback 132 enables the user 108 to quickly understand whether their input is correct and, if not, what steps they need to take to fix it. The real-time feedback 132 helps the user 108 to learn from their mistakes on the spot, thereby improving the quality of their writing and enhancing their understanding of grammar and sentence structure. The real-time feedback 132 is provided through the input interface 110 of the online learning platform 112. As soon as the AI engine 104 completes its evaluations, including token comparison, grammar checking, and semantic analysis, it generates the Boolean output 130. Depending on the outcome, the real-time feedback 132 is generated that either confirms that the user-expanded sentence 102 is correct or initiate error reporting. The real-time feedback 132 is presented to the user 108 in an understandable format, such as a message or pop-up notification.

The error reporting is the process of informing the user 108 about specific issues in the user-expanded sentence 102, when it fails evaluations. The error reporting tells the user 108 that something is wrong and identifies the exact nature of the problems, such as grammatical errors or semantic inconsistencies. The error reporting includes suggestions for how to improve or correct the sentence. When the Boolean output 130 is false, the AI engine 104 moves on to analyze the specific causes of failure reviewing the results from the grammar checking algorithm 126 and the semantic analysis to determine which areas of the user-expanded sentence 102 contain errors and then generates the error report that highlights the problematic parts of the user-expanded sentence 102. The error report includes suggestions for improvement. These suggestions are designed to guide the user 108 toward correcting the identified issues. The suggestions for improvement are constructive pieces of real-time feedback 132 given to the user 108 to help them revise the user-expanded sentence 102. The suggestions aim to guide the user 108 toward fixing grammatical errors or resolving semantic inconsistencies to improve clarity.

The exemplary pseudo-code for an embodiment of the sentence validation process 200 is given below:

The exemplary pseudo-code for another embodiment of the sentence validation process 200 is given below:

```
      1. Tokenize the candidate expanded sentence
      2. Check if there's a valid subarray of tokens within the tokenized
      expanded sentence which equals the tokenized fragment (ignoring case)
            const thisTokens = tokenizeWords(this.text.toLowerCase( ));
            const fragmentTokens =
      tokenizeWords(fragment.toString( ).toLowerCase( ));
            const thisTokensStr = thisTokens.join(′,′);
            const fragmentTokensStr = fragmentTokens.join(′,′);
            return thisTokensStr.includes(fragmentTokensStr);
      1. Run through following checks:
      - Did it pass the LanguageTool grammar check
      - Did it pass the following two semantic checks
      const template = createTemplate<{
        text: string;
      } PROMPT==>(‘You are an expert at determining if a sentence makes
      sense. Grammatically correct sentences can be semantically incorrect.
      Here's an example:
      Sentence: The mouse chases the cat.
      Explanation: While this is grammatically correct, it is not
      semantically correct because mice don't chase cats. In fact, cats chase
      mice.
      Please ignore spelling mistakes and consider sentences with typos to be
      correct if the student attempted to type a word that would have made
      sense.
      Now, please output if the sentence makes sense. If it makes sense,
      output ′Yes′. And if it makes absolutely no sense, output ′No′.
      Note, don't be super strict on factual errors. Note that young students
      are writing these sentences. Just check if the sentence is coherent and
      generally makes sense.
      {{ text }}
      ‘);
      const prompt: Prompt<{ text: string }, Boolean | null> = {
        provider: ′openai′,
        model: ′gpt-3.5-turbo′,
        template,
        parse: (content: string | undefined) => {
          return llm.helpers.parseYesNo(content || ′′);
        },
      };
const template = createTemplate<{
  text: string;
}>(‘You are an expert at determining if a sentence makes semantic sense.
Grammatically correct sentences can be semantically incorrect. Here's an
example:
Sentence: The mouse chases the cat.
Explanation: While this is grammatically correct, it is not semantically
correct because mice don't chase cats. In fact, cats chase mice.
Please ignore spelling mistakes and consider sentences with typos to be
correct if the student attempted to type a word that would have made sense.
Now, please output if the sentence is semantically correct or not. If it is
semantically correct, output ′Yes′. And if it is semantically incorrect,
output ′No′.
{{ text }}
‘);
const prompt: Prompt<{ text: string }, Boolean | null> = {
  provider: ′openai′,
  model: ′gpt-3.5-turbo′,
  template,
  parse: (content: string | undefined) => {
    return llm.helpers.parseYesNo(content || ′′);
  },
};
export default prompt;
Then:
- Check if the sentence starts with a capital letter?
- Using ‘compromise‘ js package, check if the proper nouns are properly
capitalized?
- Check if the expanded sentence ends with punctuation
```

The pseudo-code includes a function for tokenizing 116 tokenizeWords(this.text.toLowerCase( )) to convert the user-expanded sentence 102 to lowercase and tokenizes it into words. The function thisTokensStr.includes(fragmentTokensStr checks if the tokenized sentence fragment 106 exists as a valid subarray within the tokenized user-expanded sentence 102. The function Did it pass the LanguageTool grammar check verifies if the user-expanded sentence 102 passes grammar validation using. The function Determines if a sentence makes sense semantically uses GPT model to check if the user-expanded sentence 102 is coherent and generally makes sense. The function Determines if a sentence is semantically correct validates the semantic accuracy of the user-expanded sentence 102 using GPT model. The function Check if the sentence starts with a capital letter verifies that the user-expanded sentence 102 starts with a capital letter. The function Using ‘compromise’ package ensures proper nouns are capitalized. The function Check if the expanded sentence ends with punctuation confirms that the user-expanded sentence 102 ends with appropriate punctuation.

Moreover, storing in a database history of user-expanded sentences 102 and real-time feedback 132 to enable the user 108 to review past sentence fragment 106 expansions, along with the corresponding real-time feedback 132 and corrections for tracking progress, identify patterns of recurring mistakes to improve sentence construction. The database stores both the user-expanded sentences 102 and the real-time feedback 132 generated for each expansion. The database stores the original sentence fragment 106, the user-expanded sentence 102, and any corrections or error messages provided during the feedback process. In at least one embodiment, the database also includes contextual information, such as the date and time the user 108 created the user-expanded sentence 102, allowing for better tracking of progress over specific periods. Typically, storing data allows the user 108 to review past work and see how their sentence construction has improved over time. By accessing a historical record of their sentence expansions, the user 108 can reflect on the mistakes they made and the corrections they received, reinforcing their learning process. The data also provides the user 108 with an opportunity to spot patterns of recurring mistakes. If the user 108 frequently makes the same grammatical error or struggles with specific sentence structures, they can identify the issues by reviewing their past feedback and make targeted efforts to correct them in the future.

When the user 108 generates the user-expanded sentence 102 and receives real-time feedback 132, the entire interaction is logged and stored in the database. The database functions as a repository where all the user's previous inputs and the AI engine 104 responses are stored in an organized manner, allowing easy retrieval. The user 108 can access their history through the online learning platform 112. For example, if the user 108 consistently misuses punctuation, they can study the real-time feedback 132 for those mistakes and focus on learning the correct rules.

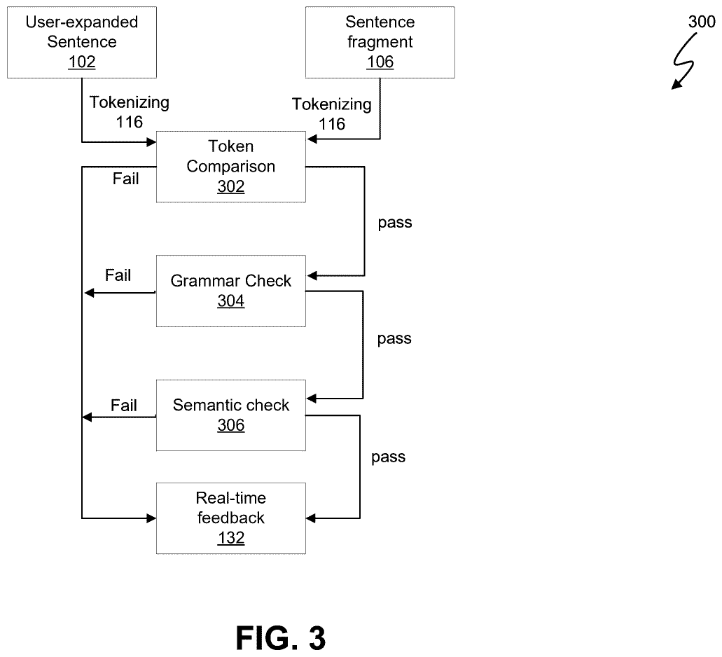

FIG. 3 depicts a decision-making process 300, which is an embodiment of the sentence validation process 200 of FIG. 2. As shown, the sentence fragment 106 and user-expanded sentence 102 are provided as an input via the online learning platform 112. Tokenizing 116 the sentence fragment 106 and user-expanded sentence 102 using word-level tokenization algorithm 118. The tokenized sentence fragment 106 and user-expanded sentence 102 is provided for token comparison 302. The token comparison 302 involves checking if the tokens match specific expected words or patterns. If the comparison fails (i.e., the tokens are invalid), the real-time feedback 132 is provided to the user 108 specifying errors. If the comparison passes (i.e., the tokens are valid), the process proceeds to a grammar check 304. The grammar check 304 checks if the user-expanded sentence 102 is grammatically correct. If the user-expanded sentence 102 fails, the real-time feedback 132 is provided to the user 108 specifying errors. If the user-expanded sentence 102 passes the grammar check, the process proceeds to semantic check 306. The semantic check 306 determines whether the user-expanded sentence 102 makes sense or carries a meaningful interpretation. If the user-expanded sentence 102 fails semantic check 306, the real-time feedback 132 is provided to the user 108 specifying errors. If the user-expanded sentence 102 passes the semantic check 306, the real-time feedback 132 provides confirmation of correctness of the user-expanded sentence 102.

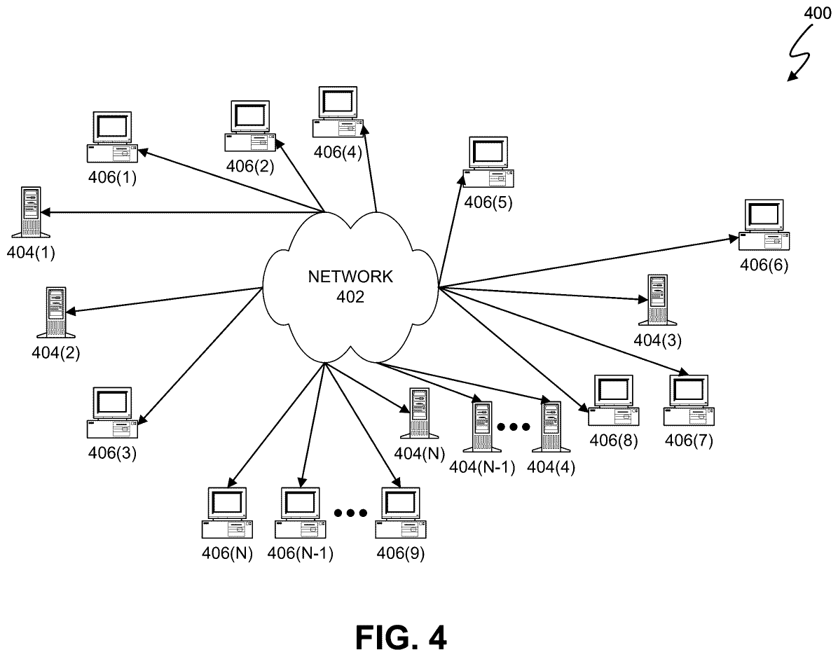

FIG. 4 is a block diagram illustrating a network environment 400 in which a sentence validation system 100 and sentence validation process 200 may be practiced. Network 402 (e.g. a private wide area network (WAN) or the Internet) includes a number of networked server computer systems 404(1)-(N) that are accessible by client computer systems 406(1)-(N), where N is the number of server computer systems connected to the network. Communication between client computer systems 406(1)-(N) and server computer systems 404(1)-(N) typically occurs over a network, such as a public switched telephone network over asynchronous digital subscriber line (ADSL) telephone lines or high-bandwidth trunks, for example communications channels providing T1 or OC3 service. Client computer systems 406(1)-(N) typically access server computer systems 404(1)-(N) through a service provider, such as an internet service provider (“ISP”) by executing application specific software, commonly referred to as a browser, on one of client computer systems 406(1)-(N).

Client computer systems 406(1)-(N) and/or server computer systems 404(1)-(N) are specialized computer programmed to improve conventional computer systems to implement and utilize the sentence validation system 100 and sentence validation process 200. The type of computer system that can be specially programmed to implement and utilize the sentence validation system 100 and sentence validation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the sentence validation system 100 and sentence validation process 200 can be implemented using code stored in a tangible, non-transient computer readable medium and executed by one or more processors. In at least one embodiment, the sentence validation system 100 and sentence validation process 200 can be implemented completely in hardware using, for example, logic circuits and other circuits including field programmable gate arrays.

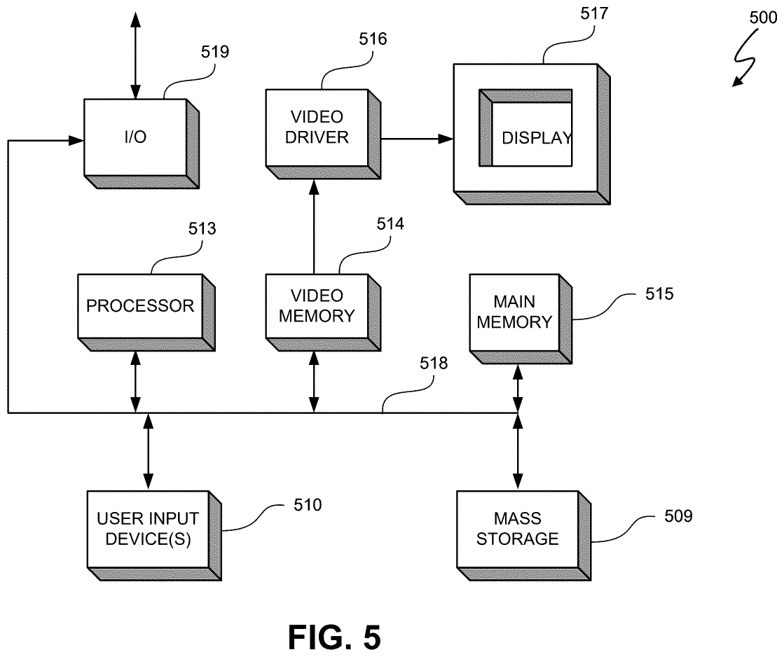

Embodiments of the sentence validation system 100 and sentence validation process 200 can be implemented on a computer system such as a special-purpose, special-programmed computer 500 illustrated in FIG. 5. Input user device(s) 510, such as a keyboard and/or mouse, are coupled to a bi-directional system bus 518. The input user device(s) 510 are for introducing user input to the computer system and communicating that user input to processor 513. The computer system of FIG. 5 generally also includes a non-transitory video memory 514, non-transitory main memory 515, and non-transitory mass storage 509, all coupled to bi-directional system bus 518 along with input user device(s) 510 and processor 513. The mass storage 509 may include both fixed and removable media, such as a hard drive, one or more CDs or DVDs, solid state memory including flash memory, and other available mass storage technology. Bus 518 may contain, for example, 32 of 64 address lines for addressing video memory 514 or main memory 515. The system bus 518 also includes, for example, an n-bit data bus for transferring DATA between and among the components, such as CPU 509, main memory 515, video memory 514 and mass storage 509, where “n” is, for example, 32 or 64. Alternatively, multiplex data/address lines may be used instead of separate data and address lines.

I/O device(s) 519 may provide connections to peripheral devices, such as a printer, and may also provide a direct connection to a remote server computer systems via a telephone link or to the Internet via an ISP. I/O device(s) 519 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 509, into main memory 515 for execution. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 513, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 515 is comprised of dynamic random access memory (DRAM). Video memory 514 is a dual-ported video random access memory. One port of the video memory 514 is coupled to video amplifier 516. The video amplifier 516 is used to drive the display 517. Video amplifier 516 is well known in the art and may be implemented by any suitable means. This circuitry converts pixel DATA stored in video memory 514 to a raster signal suitable for use by display 517. Display 517 is a type of monitor suitable for displaying graphic images.

The computer system described above is for purposes of example only. The sentence validation system 100 and sentence validation process 200 may be implemented in any type of computer system or programming or processing environment. It is contemplated that the sentence validation system 100 and sentence validation process 200 might be run on a stand-alone computer system, such as the one described above. The sentence validation system 100 and sentence validation process 200 might also be run from a server computer systems system that can be accessed by a plurality of client computer systems interconnected over an intranet network. Finally, the sentence validation system 100 and sentence validation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method for guiding an Artificial Intelligence (AI) engine for determining the semantic and grammatical correctness of a user-expanded sentence in real-time comprising:
executing code using one or more processors of a computer system to cause the computer system to perform operations comprising:
receiving, via an input interface, a sentence fragment and the user-expanded sentence from a user;
tokenizing the sentence fragment and the user-expanded sentence using a word-level tokenization algorithm, wherein receiving both the sentence fragment and the user-expanded sentence via an application programming interface (API) and the tokenization includes breaking down the text into discrete tokens, based on spaces, punctuation, and other delimiters;
comparing the tokens of the sentence fragment and the user-expanded sentence using a token comparison algorithm, wherein the comparison involves determining whether the meaning of the sentence fragment is preserved in the user-expanded sentence by assessing the presence, order, and contextual alignment of the corresponding tokens in both sentence fragment and user-expanded sentence;
generating a prompt by a prompt generator to guide the AI engine to determine the semantic and grammatical correctness of the user-expanded sentence;
transferring the prompt to the AI engine, wherein the AI engine is configured to:
evaluate the grammatical correctness of the user-expanded sentence using a grammar checking algorithm, wherein the grammar checking algorithm identifies grammatical errors including syntax mistakes, punctuation errors, and improper sentence structures;
perform a semantic analysis of the user-expanded sentence using a natural language processing (NLP) model, wherein the NLP model determine whether the meaning conveyed by the user-expanded sentence is logically consistent with the sentence fragment;
synthesizing the results of the token comparison, grammar correctness, and semantic analysis to generate a Boolean output, wherein the Boolean output indicates whether the user-expanded sentence is semantically and grammatically correct relative to the sentence fragment; and
providing real-time feedback to the user based on the Boolean output, wherein the feedback includes either confirmation of correctness or detailed error reporting that identifies specific grammatical or semantic inconsistencies and provides suggestions for improving the user-expanded sentence.

2. The method of claim 1 wherein, tokenizing the sentence fragment and the user-expanded sentence comprises the use of the word-level tokenization algorithm that identifies tokens by splitting the text into individual units based on spaces, punctuation marks, and other delimiters.

3. The method of claim 1 wherein, comparing the tokens of the sentence fragment and the user-expanded sentence comprises using the token comparison algorithm that evaluates presence of tokens and relative order and position within the sentence.

4. The method of claim 1 wherein, evaluating the grammatical correctness of the user-expanded sentence comprises utilizing the grammar checking algorithm integrated with a grammar evaluation tool to identify grammatical issues including subject-verb agreement errors, run-on sentences, improper punctuation usage, misplaced modifiers, and stylistic concerns.

5. The method of claim 1 wherein performing semantic analysis on the user-expanded sentence comprises using a multi-stage approach, wherein the semantic analysis evaluates the syntactic structure of the user-expanded sentence to determine whether the meaning conveyed by the user-expanded sentence aligns with the intended meaning of the sentence fragment.

6. The method of claim 1 wherein comparing the tokens of the sentence fragment and the user-expanded sentence comprises handling cases where the user-expanded sentence includes additional contextual information not present in the sentence fragment, wherein the token comparison algorithm evaluates whether such added information alters the original meaning of the sentence fragment, and rejects the expansion if significant deviations in meaning are detected.

7. The method of claim 1 wherein receiving the sentence fragment and the user-expanded sentence from a user devices integrating the input interface through the API to enable interaction.

8. The method of claim 1 wherein evaluating the grammatical correctness of the user-expanded sentence comprises assessing stylistic elements of the sentence, including sentence length, complexity, tone, and readability to provide the user with an enhanced assessment of the overall quality and effectiveness of the sentence.

9. The method of claim 1 further comprising:
storing in a database history of user-expanded sentences and real-time feedback to enable the user to review past sentence fragment expansions, along with the corresponding feedback and corrections for tracking progress, identify patterns of recurring mistakes to improve sentence construction.

10. A system for guiding an Artificial Intelligence (AI) engine for determining the semantic and grammatical correctness of a user-expanded sentence in real-time comprising:
one or more processors of a computer system; and
memory, coupled to the one or more processors, that stores code and execution of the code by the one or more processors causes the computer system to perform operations comprising:
receiving, via an input interface, a sentence fragment and the user-expanded sentence from a user:
tokenizing the sentence fragment and the user-expanded sentence using a word-level tokenization algorithm, wherein receiving both the sentence fragment and the user-expanded sentence via an application programming interface (API) and the tokenization includes breaking down the text into discrete tokens, based on spaces, punctuation, and other delimiters;
comparing the tokens of the sentence fragment and the user-expanded sentence using a token comparison algorithm, wherein the comparison involves determining whether the meaning of the sentence fragment is preserved in the user-expanded sentence by assessing the presence, order, and contextual alignment of the corresponding tokens in both sentence fragment and user-expanded sentence;
generating a prompt by a prompt generator to guide the AI engine to determine the semantic and grammatical correctness of the user-expanded sentences;
transferring the prompt to the AI engine, wherein the AI engine is configured to:
evaluate the grammatical correctness of the user-expanded sentence using a grammar checking algorithm, wherein the grammar checking algorithm identifies grammatical errors including syntax mistakes, punctuation errors, and improper sentence structures;
perform a semantic analysis of the user-expanded sentence using a natural language processing (NLP) model, wherein the NLP model determine whether the meaning conveyed by the user-expanded sentence is logically consistent with the sentence fragment;
synthesizing the results of the token comparison, grammar correctness, and semantic analysis to generate a Boolean output, wherein the Boolean output indicates whether the user-expanded sentence is semantically and grammatically correct relative to the sentence fragment; and
providing real-time feedback to the user based on the Boolean output, wherein the feedback includes either confirmation of correctness or detailed error reporting that identifies specific grammatical or semantic inconsistencies and provides suggestions for improving the user-expanded sentence.

11. The system of claim 10 wherein, tokenizing the sentence fragment and the user-expanded sentence comprises the use of the word-level tokenization algorithm that identifies tokens by splitting the text into individual units based on spaces, punctuation marks, and other delimiters.

12. The system of claim 10 wherein, comparing the tokens of the sentence fragment and the user-expanded sentence comprises using the token comparison algorithm that evaluates presence of tokens and relative order and position within the sentence.

13. The system of claim 10 wherein, evaluating the grammatical correctness of the user-expanded sentence comprises utilizing the grammar checking algorithm integrated with a grammar evaluation tool to identify grammatical issues including subject-verb agreement errors, run-on sentences, improper punctuation usage, misplaced modifiers, and stylistic concerns.

14. The system of claim 10 wherein performing semantic analysis on the user-expanded sentence comprises using a multi-stage approach, wherein the semantic analysis evaluates the syntactic structure of the user-expanded sentence to determine whether the meaning conveyed by the user-expanded sentence aligns with the intended meaning of the sentence fragment.

15. The system of claim 10 wherein comparing the tokens of the sentence fragment and the user-expanded sentence comprises handling cases where the user-expanded sentence includes additional contextual information not present in the sentence fragment, wherein the token comparison algorithm evaluates whether such added information alters the original meaning of the sentence fragment, and rejects the expansion if significant deviations in meaning are detected.

16. The system of claim 10 wherein receiving the sentence fragment and the user-expanded sentence from a user device integrating the input interface through the API to enable interaction.

17. The system of claim 10 wherein evaluating the grammatical correctness of the user-expanded sentence comprises assessing stylistic elements of the sentence, including sentence length, complexity, tone, and readability to provide the user with an enhanced assessment of the overall quality and effectiveness of the sentence.

18. The system of claim 10 further comprising:
storing in a database history of user-expanded sentences and real-time feedback to enable the user to review past sentence fragment expansions, along with the corresponding feedback and corrections for tracking progress, identify patterns of recurring mistakes to improve sentence construction.
